(19) United States
(12) Patent Application Publication
(10) Pub. No.: US 2011/0022451 A1
(43) Pub. Date: Jan. 27, 2011

(54) ADVERTISING CONTENT FOR MOBILE DEVICES

(75) Inventors: Joseph H. Jardine, Farmington, UT (US); John L. Webster, Draper, UT (US); Robert A. Williams, West Jordan, UT (US)

Correspondence Address: JARDINE LAW OFFICES, 116 129TH AVENUE NE, BELLEVUE, WA, 98005, US

(73) Assignee: MOBILE GENIUS, LLC, Salt Lake City, UT (US)

(21) Appl. No.: 12/844,608

(22) Filed: Jul. 27, 2010

Related U.S. Application Data
(60) Provisional application No. 61/228,903, filed on Jul. 27, 2009.

(51) Int. Cl. G06Q 30/00

(52) U.S. Cl. 705/14.4

(57) ABSTRACT

Aspects of the subject matter described herein relate to advertising content for mobile devices. In aspects, advertising content is downloaded to a mobile device when the mobile device is connected to a network. The advertising content is stored on a storage media of the mobile device. Later, a user may search the advertising content of the mobile device without connecting the mobile device to a network. Because the advertising content is downloaded to the mobile device, the advertising content may be accessed more quickly. Additionally, the advertising content may be sized to be suited for the display size of the mobile device.

### CROSS REFERENCE TO RELATED APPLICATION

This application claims the benefit of U.S. Provisional Application No. 61/228,903, filed Jul. 27, 2009, entitled ADVERTISING CONTENT FOR MOBILE DEVICES, which application is incorporated herein in its entirety.

### BACKGROUND

Advertising content created for the World Wide Web is often developed with a personal computer in mind. Modern personal computers often have efficient input devices such as keyboards and mice and large displays with good resolution—particularly when compared with mobile devices. Advertising content created for the characteristics of a personal computer is often not suitable for a mobile device. To view advertising content created for a personal computer on a mobile device may involve zooming in and out, scrolling in one or more directions, and other actions. As a result, a person using a mobile device may become frustrated when accessing advertising content that was created for a personal computer.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to advertising content for mobile devices. In aspects, advertising content is downloaded to a mobile device when the mobile device is connected to a network. The advertising content is stored on a storage media of the mobile device. Later, a user may search the advertising content of the mobile device without connecting the mobile device to a network. After the advertising content is downloaded to the mobile device, the advertising content may be accessed more quickly. Additionally, the advertising content may be sized to be suited for the display size of the mobile device.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary mobile device into which aspects of the subject matter described herein may be incorporated;

FIG. 2 is a block diagram that represents an exemplary environment in which aspects of the subject matter described herein may be implemented;

FIG. 3 illustrates some elements of an exemplary user interface that may be used to access content in accordance with aspects of the subject matter described herein;

FIG. 4 illustrates some elements of an exemplary user interface that may be displayed when showing ads associated with a category in accordance with aspects of the subject matter described herein;

FIG. 5 illustrates some elements of an exemplary user interface that may be displayed when showing listings associated with a category in accordance with aspects of the subject matter described herein;

FIG. 6 is a block diagram that includes content components of an exemplary mobile device configured in accordance with aspects of the subject matter described herein;

FIG. 7 is a flow diagram that generally represents exemplary actions that may occur on a mobile device in accordance with aspects of the subject matter described herein; and

FIG. 8 is a flow diagram that generally represents exemplary actions that may occur to update content in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “one or more embodiments.” The term “another embodiment” is to be read as “one or more other embodiments.” Other definitions, explicit and implicit, may be included below.

### Exemplary Operating Environment

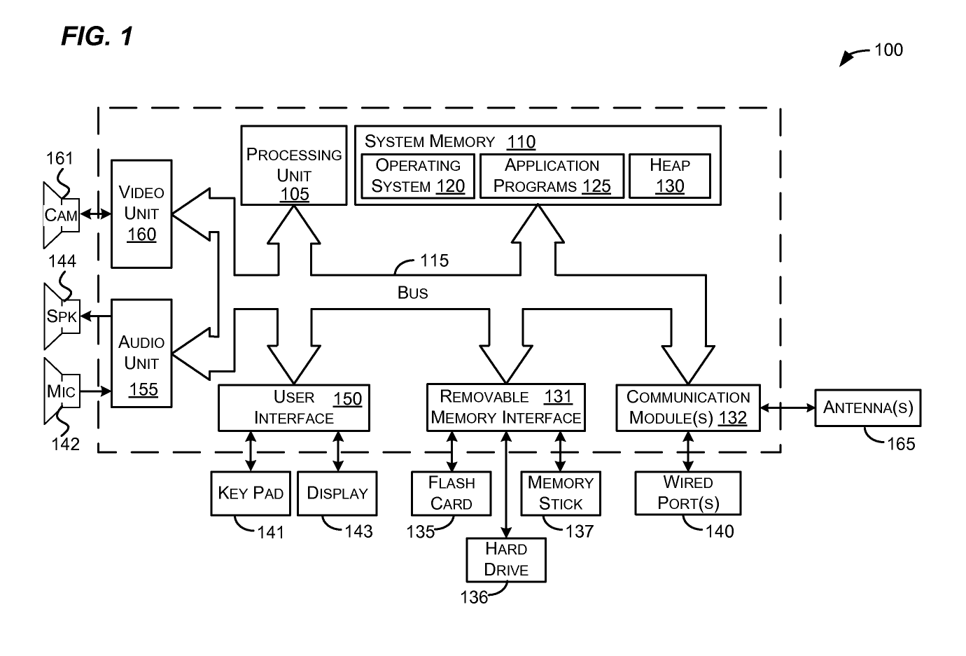

FIG. 1 illustrates an example of a suitable mobile device 100 on which aspects of the subject matter described herein may be implemented. The mobile device 100 is only one example of a device and is not intended to suggest any limitation as to the scope of use or functionality of aspects of the subject matter described herein. Neither should the mobile device 100 be interpreted as having any dependency or requirement relating to any one or combination of components illustrated in the exemplary mobile device 100.

With reference to FIG. 1, an exemplary device for implementing aspects of the subject matter described herein includes a mobile device 100. In some embodiments, the mobile device 100 comprises a cell phone, a handheld device that allows voice communications with others, some other voice communications device, or the like. In some embodiments, a mobile device 100 may be equipped with a camera 161 for taking pictures, although in other embodiments, the mobile device 100 may not include the camera 161. In other embodiments, the mobile device 100 comprises a personal digital assistant (PDA), hand-held gaming device, other hand held device, printer, appliance including a set-top, media center, or other appliance, automobile-embedded or attached computing devices, other mobile devices, or the like. Some exemplary devices that may implement the mobile device 100 include the iPod iTouch and the iPhone produced by Apple Inc., BlackBerry® devices produced by Research in Motion, and cell phones produced by various manufacturers.

Components of the mobile device 100 may include, but are not limited to, a processing unit 105, system memory 110, and a bus 115 that couples various system components including the system memory 110 to the processing unit 105. The bus 115 may include any of several types of bus structures including a memory bus, memory controller, a peripheral bus, and a local bus using any of a variety of bus architectures, and the like. The bus 115 allows data to be transmitted between various components of the mobile device 100.

The mobile device 100 may include a variety of computer-readable media. Computer-readable media can be any available media that can be accessed by the mobile device 100 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 100.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, WiFi, WiMAX, and other wireless media. Combinations of any of the above should also be included within the scope of computer-readable media.

The system memory 110 includes computer storage media in the form of volatile and/or nonvolatile memory and may include read only memory (ROM) and random access memory (RAM). On a mobile device such as a cell phone, operating system code 120 is sometimes included in ROM although, in other embodiments, this is not required. Similarly, application programs 125 are often placed in RAM although again, in other embodiments, application programs may be placed in ROM or in other computer-readable memory. The heap 130 provides memory for state associated with the operating system code 120 and the application programs 125. For example, the operating system code 120 and application programs 125 may store variables and data structures in the heap 130 during their operations.

The mobile device 100 may also include other removable/non-removable, volatile/nonvolatile memory. By way of example, FIG. 1 illustrates a flash card 135, a hard disk drive 136, and a memory stick 137. The hard disk drive 136 may be miniaturized to fit in a memory slot, for example. The mobile device 100 may interface with these types of non-volatile removable memory via a removable memory interface 131, or may be connected via a universal serial bus (USB), IEEE 1394, one or more of the wired port(s) 140, or antenna(s) 165. In these embodiments, the removable memory devices 135-137 may interface with the mobile device via the communications module(s) 132. In some embodiments, not all of these types of memory may be included on a single mobile device. In other embodiments, one or more of these and other types of removable memory may be included on a single mobile device.

In some embodiments, the hard disk drive 136 may be connected in such a way as to be more permanently attached to the mobile device 100. For example, the hard disk drive 136 may be connected to an interface such as parallel advanced technology attachment (PATA), serial advanced technology attachment (SATA), or otherwise, which may be connected to the bus 115. In such embodiments, removing the hard drive may involve removing a cover of the mobile device 100 and removing screws or other fasteners that connect the hard drive 136 to support structures within the mobile device 100.

The removable memory devices 135-137 and their associated computer storage media, discussed above and illustrated in FIG. 1, provide storage of computer-readable instructions, program modules, data structures, and other data for the mobile device 100. For example, the removable memory device 135-137 may store images taken by the mobile device 100, voice recordings, contact information, programs, data for the programs, and so forth.

A user may enter commands and information into the mobile device 100 through input devices such as a key pad 141 and the microphone 142. In some embodiments, the display 143 may be touch-sensitive screen and may allow a user to enter commands and information thereon. The key pad 141 and display 143 may be connected to the processing unit 105 through a user input interface 150 that is coupled to the bus 115, but may also be connected by other interface and bus structures, such as the communications module(s) 132 and wired port(s) 140.

A user may communicate with other users via speaking into the microphone 142 and via text messages that are entered on the key pad 141 or a touch sensitive display 143, for example. The audio unit 155 may provide electrical signals to drive the speaker 144 as well as receive and digitize audio signals received from the microphone 142.

The mobile device 100 may include a video unit 160 that provides signals to drive a camera 161. The video unit 160 may also receive images obtained by the camera 161 and provide these images to the processing unit 105 and/or memory included on the mobile device 100. The images obtained by the camera 161 may comprise video, one or more images that do not form a video, or some combination thereof.

The communications module(s) 132 may provide signals to and receive signals from one or more antenna(s) 165. One of the antenna(s) 165 may transmit and receive messages for a cell phone network. Another antenna may transmit and receive Bluetooth® messages. Yet another antenna may transmit and receive network messages via a wireless Ethernet network standard.

In some embodiments, a single antenna may be used to transmit and/or receive messages for more than one type of network. For example, a single antenna may transmit and receive voice and packet messages.

When operated in a networked environment, the mobile device 100 may connect to one or more remote devices. The remote devices may include a personal computer, a server, a router, a network PC, a cell phone, a peer device or other common network node, and typically includes many or all of the elements described above relative to the mobile device 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is sometimes used herein, it will be recognized that this term may also encompass a client, a set of one or more processes distributed on one or more computers, one or more stand-alone storage devices, a set of one or more processes on one or more mobile devices, a set of one or more other devices, a combination of one or more of the above, and the like.

Although the terms “mobile device” and “server” are sometimes used herein, it is to be understood, that a mobile device may be implemented on a machine that has hardware and/or software that is typically associated with a server and that likewise, a server may be implemented on a machine that has hardware and/or software that is typically associated with a desktop, personal, or mobile device. Furthermore, a mobile device may at times act as a server and vice versa. In an embodiment, a mobile device and a server may, at various times, both be peers, servers, or clients. In one embodiment, mobile device and server may be implemented on the same physical machine.

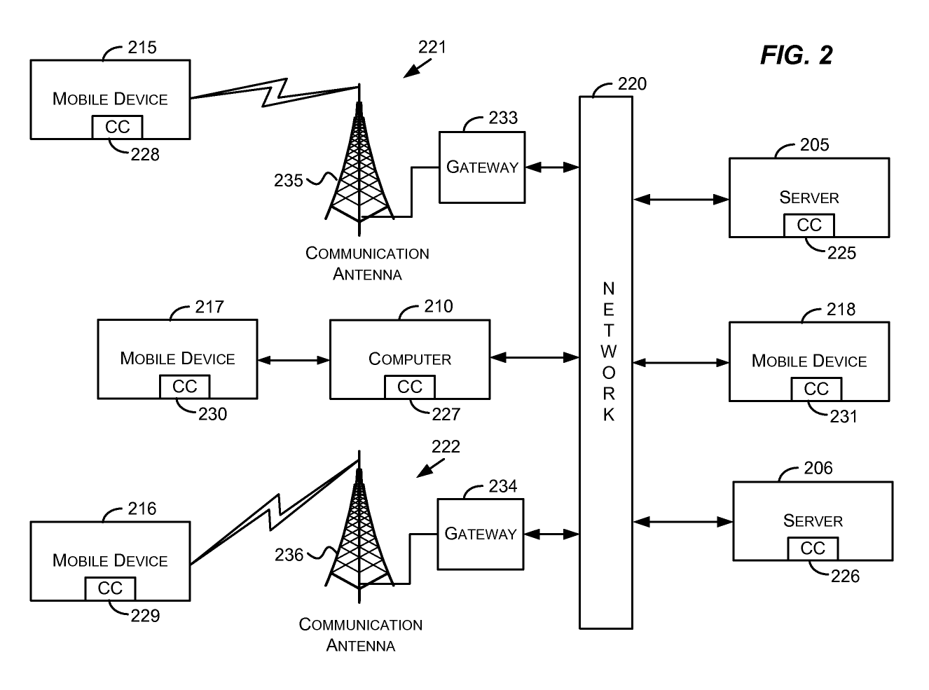

FIG. 2 is a block diagram that represents an exemplary environment in which aspects of the subject matter described herein may be implemented. The environment includes servers 205-206, computer 210, and mobile devices 215-218 (hereinafter sometimes collectively referred to as the entities) and may include other components (not shown). Sometimes a server, computer, or mobile device is referred to as an entity, and two or more of the servers, computer, or mobile devices may be referred to as entities. The entities may communicate with each other via various networks including intra- and inter-office networks, telephone lines, the network 220, wireless networks 221 and 222, other wireless and wired networks, and the like. In one embodiment, the network 220 may comprise the Internet.

A wireless network (e.g., each of the wireless networks 235 and 236) may comprise one or more components that are capable of communicating with mobile devices wirelessly. The wireless networks 221 and 222 may be connected to or incorporated in the gateways 233 and 234, respectively. A gateway may function as a conduit to allow communications to and from the mobile devices 215 and 216 to entities connected to the network 220. A wireless network may function according to one or more of various protocols including a cellular protocol, Bluetooth (also known as IEEE 802.15), those defined by IEEE 802.11, and other wireless network protocols, for example. In cellular network implementations, the gateways 233-234 may be implemented as part of or separate from mobile telephone switching offices that may control the operation of a cellular sub-system.

A mobile device (e.g., the mobile device 217) may connect to one or more other entities via the computer 210. The mobile device 217 may be connected to the computer via a wired (e.g., Universal Serial Bus (USB), IEEE 1394 (also known as “FireWire”), or some other wired protocol) or wireless (e.g., Bluetooth, radio, or some other wireless protocol) connection. In some embodiments, the mobile device 217 may access content from the computer 210 and may only connect to the computer 210 and not to the other entities illustrated in FIG. 2 to access the content. Access as used herein may include reading data, writing data, deleting data, updating data, a combination including one or more of the above, and the like.

A mobile device (e.g., the mobile device 218) may be able to connect directly to the network 220. For example, the mobile device 218 may have a port that allows an Ethernet cable to connect to the mobile device 218. The mobile device 218 may use the Ethernet cable to connect to a router, switch, or the like that is part of the network 220. As another example, the mobile device 218 may have an antenna that allows the mobile device 218 to connect to a wireless router that is part of the network 220.

Wherever the term “mobile device” is used herein, in one embodiment, this term means a device that is designed to be held in one or two hands while interacting with the device. Such devices include cell phones, PDAs, hand held gaming devices, and the like. In other embodiments, this term means a computing device that is designed to generally not be held in human hands while being used. Such devices include personal computers, lap top computers, notebook computers, automobile-embedded or attached computing devices, other mobile devices, non-mobile devices, land-line based phones with or without a display, computing appliances, printers, and the like. In one embodiment, the mobile devices 215-218 may be implemented as described in conjunction with the mobile device 100 of FIG. 1.

Each of the servers 205-206 and the computer 210 may be implemented on one or more computers and there is no intention to limit the types of computers to those thought particularly as server computers or client computers. Indeed a computer that acts as a home computer may at times serve as a server computer and vice versa. Furthermore, in an embodiment, a server may indeed be another mobile device and may share content with a requesting mobile device in a peer-to-peer manner.

The servers 205-206, computer 210, and the mobile devices 215-218 may include content components 226-231, respectively. The content components 226-231 may comprise components that allow the entities to access or provide content. On the mobile device 215, for example, the content components 228 may comprise, for example, an application that displays content on a display of the mobile device 215.

The content components 228 may also comprise interface components that allow the application to obtain updated content from the computer 210 or one or more of the servers 205-206. On the server side, the content components 225-226 may include a web server, portal, application server, database, FTP site, other content providing software, related software, or the like. The content component 227 of the computer 210 may have components that provide content to the mobile device 217 as well as components that access content from one or more of the server 205-206.

As used herein, the term component is to be read to include all or a portion of a device, one or more processes executing on one or more devices, some combination of one or more processes and one or more devices, and the like. The term “process” and its variants as used herein may include one or more traditional processes, threads, libraries, objects that perform tasks, and the like. A process may be implemented in hardware, software, or a combination of hardware and software. In an embodiment, a process is any mechanism, however called, capable of or used in performing an action. A process may be distributed over multiple devices or a single device.

Although the environment described above includes various numbers of each of the entities and related infrastructure, it will be recognized that more, fewer, or a different combination of these entities and others may be employed without departing from the spirit or scope of aspects of the subject matter described herein. Furthermore, the entities and communication networks included in the environment may be configured in a variety of ways as will be understood by those skilled in the art without departing from the spirit or scope of aspects of the subject matter described herein.

### Content

As mentioned previously, advertising content created for the display and input characteristics of a computer may not be suitable or ideal for a mobile device. Furthermore, some mobile devices may have relatively slow, intermittent, or no access to the Internet. Because of this, the search for some advertising content has migrated primarily to the computer.

As used herein, the term “advertising content” (sometimes referred to simply as “content”) means graphics, text, or the like that is meant to provide information about one or more individuals, businesses, entities, or the like. The term entity is often used herein and, when not referring to an entity of the type mentioned in conjunction with FIG. 2, is intended to mean one or more individuals, businesses, organizations, or the like. Although advertising content may be provided to solicit a sale it is not limited to content that solicits a sale. For example, a non-profit entity may want to let others know contact information with which people of the entity may be contacted.

In one embodiment, advertising content may be associated with a geographical region that includes one city or two or more cities that are adjacent to each other. In one embodiment, the geographical region may include a region that is smaller than a county, state, country, continent, or other geographical region that includes the two or more cities. For example, a geographical region may include Salt Lake City together with one or more cities that are close to Salt Lake City such as Sandy, South Jordan, Ogden, Orem, and so forth.

Advertising content may include map information for the geographical region associated with the advertising content. Including this map information may allow a mobile device that does not have a connection to the Internet to nevertheless display maps of and directions to locations of entities associated with the advertising content.

In accordance with aspects of the subject matter described herein, content to be accessed by a mobile device may be categorized. For example, content may be categorized by a type of service or good provided (e.g., accounting services, legal services, construction services, automobile dealerships, automobile repair, plumbers).

A category may have one or more subcategories. For example, a paint category may include automotive, removing, retail, wholesale, manufacturers, consultants, contractors, and other subcategories. A subcategory may also include one or more subcategories. Although a depth of two or three subcategories may be sufficient for most content, the depth of subcategories under any particular category may continue up to any depth.

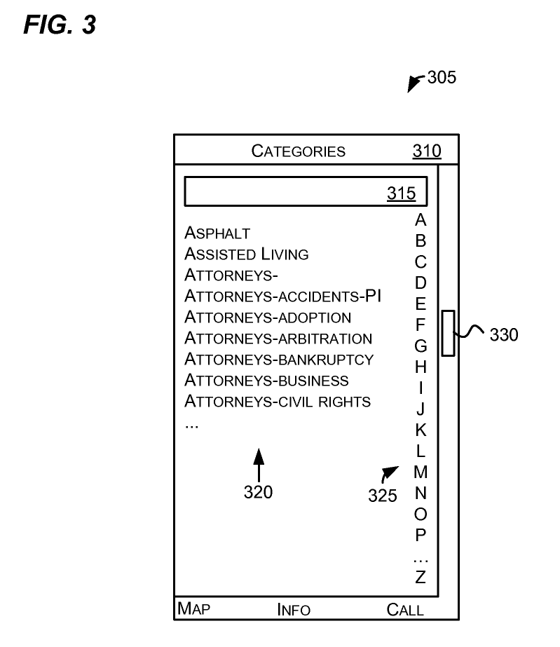

FIGS. 3-5 include exemplary user interfaces that may be used in accordance with various aspects of the subject matter described herein. The user interfaces may include other elements not shown and/or remove and/or replace elements shown with other elements. By providing the interfaces illustrated in these figures, there is no intention to be all-inclusive or exhaustive of the different types of interfaces that may be used to provide the same results as described herein. Indeed, based on the teachings herein, one of skill in the art may recognize many alternative user interfaces that may be utilized to provide the same results without departing from the spirit or scope of aspects of the subject matter described herein.

Turning to FIG. 3, FIG. 3 illustrates some elements of an exemplary user interface that may be used to access content in accordance with aspects of the subject matter described herein. As illustrated, the user interface 305 includes a title 310, a search field 315, categories 320, hierarchical navigation elements 325, and a scrolling element 330.

Although the scrolling element 330 is illustrated in FIG. 3, in one embodiment, there may not be a visual representation of the scrolling element 330. Instead, other user actions (e.g., moving a finger along a touch-sensitive screen, voice commands such as “scroll up,” “scroll down,” and the like, tilting or otherwise moving a device, moving a scroll wheel, pressing electromechanical buttons, and the like) may be used to indicate that the user seeks to navigate the list. Whenever an action of using the scrolling element 330 is mentioned herein, it is to be understood that in other embodiments, other user actions may be performed to indicate that scrolling is desired.

The title 310 is a user interface element that indicates what the user interface 305 is displaying.

The search field 315 may be used to enter text to search for particular categories or business names. For example, to search for plumbers, a user may select the search field 315 and begin entering the letters of the word “plumber.” As the user enters letters, the user interface 305 may interactively display categories that include the portion of the word entered so far. For example, after the user types the letter “p”, the user interface 305 may display pawnbrokers, physicians, printers, pizza, picture frames, plumbing contractors, and so forth. After the user types the letter “l”, the user interface 305 may display plumbing contractors, plumbing drains, plumbing fixtures, playground equipment, plants-interior design, plants-retail, and so forth. At any point at which the user sees the desired category, the user may select the desired category.

In addition to, or as an alternative to, using the search field 315 to find a category, a user may scroll through a listing of categories using the scrolling element 330. As another alternative, the user may select an element (e.g., the “P”) of the hierarchical navigation elements 325 to navigate to the start of the categories that start with “P”.

As another alternative, instead of displaying the categories 320, the user interface 305 may first display the letters A-Z spaced such that it is relatively easy to select a single letter. This may involve allotting enough space between the letters such that to see all the letters some scrolling is needed. After the user has selected a letter, main categories starting with the selected letter may be displayed. After the user has selected a main category, subcategories, if any, associated with the main category are displayed. After the user has selected a subcategory, subcategories, if any, associated with the subcategory are displayed, and so forth. The term category as used herein may refer to a main category or any subcategory.

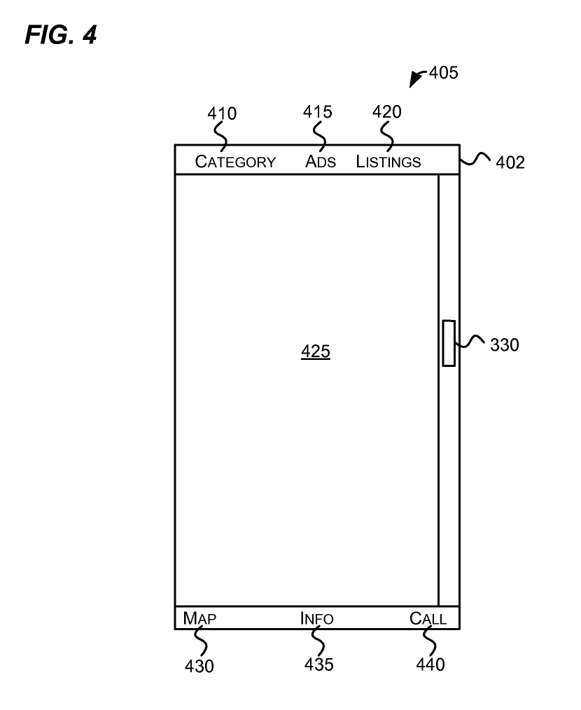

When the user selects a category, the content component on the device may determine whether any graphical based ads are associated with the category. If so, the user interface 305 may display the first such ad and provide user interface elements that allow the user to provide a map of where the entity associated with the ad is located, call or display a number associated with the ad, obtain additional information about the entity, return to the category listing, display of list of entities associated with the category, and the like. An exemplary illustration of some elements of an exemplary user interface that may be displayed when a user selects a category is illustrated in FIG. 4.

Turning to FIG. 4, the user interface 405 includes a title bar 402 that includes a category element 410, a title element 415, and a listings element 420. By selecting the category element 410, a user may navigate back to a category view. By selecting the listings element 420, the user may navigate to listings associated with the category. The title element 415 indicates that the content displayed in the pane 425 is an ad (as compared to a listing).

The content included in the pane 425 may include graphics associated with an entity (e.g., a picture of one or more professionals of the entity, a drawing of an example of what the entity does (e.g., yard work), a map that shows how to get to a place of the entity from a well known street, text that describes what the entity does, business hours, trademark or other protected content associated with the entity, an official name of the entity, one or more addresses of the entity, one or more telephone numbers associated with the entity, a Uniform Resource Locator (URL) that identifies a web site, an e-mail address, other content, and the like. About anything an entity desires to indicate about itself may be placed in the pane 425 through the use of text and graphics.

The content included in the pane 425 may be designed to fit in a single page such that it may be viewed without scrolling or may be sized such that scrolling is needed to see the entire content. Device characteristics (e.g., screen size) may be queried by or otherwise provided to a server so that the server can provide content sized appropriately to the mobile device.

When a device has network connectivity (including cell phone connectivity), selecting a URL found in advertising content may cause a Web site identified by the URL to be downloaded to and displayed by the device. Likewise, when a device has network connectivity, selecting an e-mail address found in advertising content may cause a user interface element to appear to allow the user to send e-mail, text messages, or other electronic information to the e-mail address.

The map element 430 when selected may cause a map to a location associated with the entity to be displayed. If the location of the device hosting the user interface is known (e.g., through GPS, cellular, or other means) or is provided by the user, the map may include directions from the current location to the location of the entity. If the user enters address information, the map element 430 may, when selected, cause a map to be displayed that shows directions from the entered address information to the location of the entity. If location of the user is not known and the user does not enter an address, a map may be displayed that shows how to get to the location of the entity from a well known street. In an embodiment, when the user closes the map, the advertising content that was displayed just prior to opening the map may be re-displayed.

In another embodiment, when a map to a location of an entity is displayed, a miniature ad, thumbnail, or other user interface element may be displayed on the map next to the location. By selecting the ad, thumbnail, or other user interface element, the user may indicate a desire to close the map and return to an ad or other advertising content associated with the entity. In response to receiving a user selection, the mobile device may close the map and display an ad or other advertising content associated with the entity.

When the info element 435 is selected, certain information about the entity may be displayed in a text-based way. For example, this information may include the name of the entity, the address of the entity, one or more telephone numbers, hours that the entity is open, a person to contact, a Web site associated with the entity, an e-mail address associated with the entity, and the like. This information may be displayed in way that is standardized across entities so that a user may readily recognize the information displayed.

When the call element 440 is selected, if the device that hosts the user interface 405 has calling capabilities, a number associated with the business may be called. The number may be tagged (e.g., in a database) to indicate that the number is the primary contact number for the business. Alternatively, a list of telephone numbers and perhaps associated information (e.g., names, type of number such as toll-free, fax, etc., and the like) may be displayed. If the device has calling capabilities, when the user selects from the list, the number selected may be called.

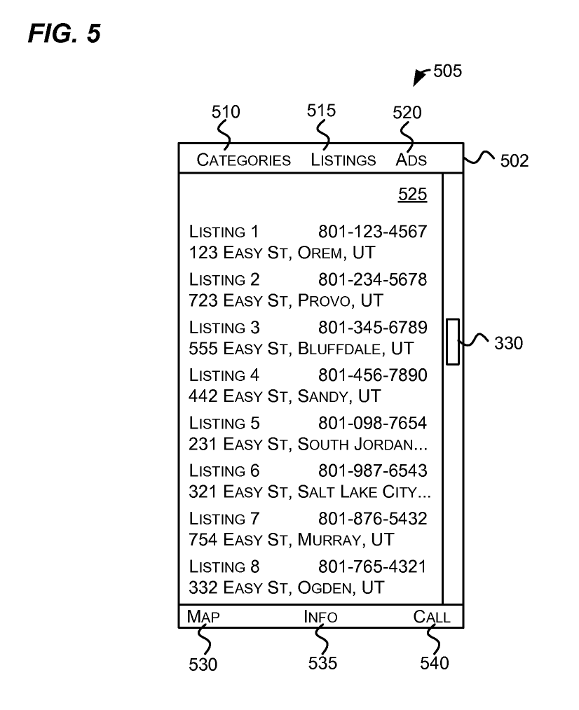

If additional information about an entity is available, a user may page down to view one or more pages of information about the business. If the user scrolls to the right, an ad for another entity of the category, if any, may be displayed. If there are no additional entities that have ads for the category, then when a user scrolls to the right, a listing of all entities of the category may be displayed as illustrated in FIG. 5, which illustrates some elements of an exemplary user interface that may be displayed when showing listings associated with a category in accordance with aspects of the subject matter described herein. Note that a user may also cause listings to be displayed by selecting the listings element 420.

Turning to FIG. 5, the user interface 505 includes a title bar 502 that includes a category element 510, a title element 515, and an ads element 520. By selecting the category element 510, a user may navigate back to a category view. By selecting the ads element 520, the user may navigate to ads associated with the category (e.g., the user interface illustrated in FIG. 4). The title element 515 indicates that the content displayed in the pane 525 includes listings.

The pane 525 displays one or more listings that are associated with a selected category. A listing includes contact information about an entity. A listing may include one or more of a thumbnail, entity name, a phone number, an address, other information, and the like. If a listing includes information that is too large for the space allotted to the listing ellipses or other indicators may be placed in or next to the listing to indicate that additional information regarding the entity is available. If more listings are available than fit on one page of the user interface, a user may scroll down to the other listings using the scrolling element 330.

A user may select the map element 530, the info element 535, or the call element 540 in conjunction with selecting a listing. Selecting these elements may have a similar effect to selecting the corresponding elements (e.g., the map element 430, the info element 435, and the call element 440) of FIG. 4. In addition, or alternatively, when a user selects a listing, another page of information regarding the entity may be displayed. This new page may include user interface elements that allow a user to indicate a desired action corresponding to the elements 530, 535, and 540.

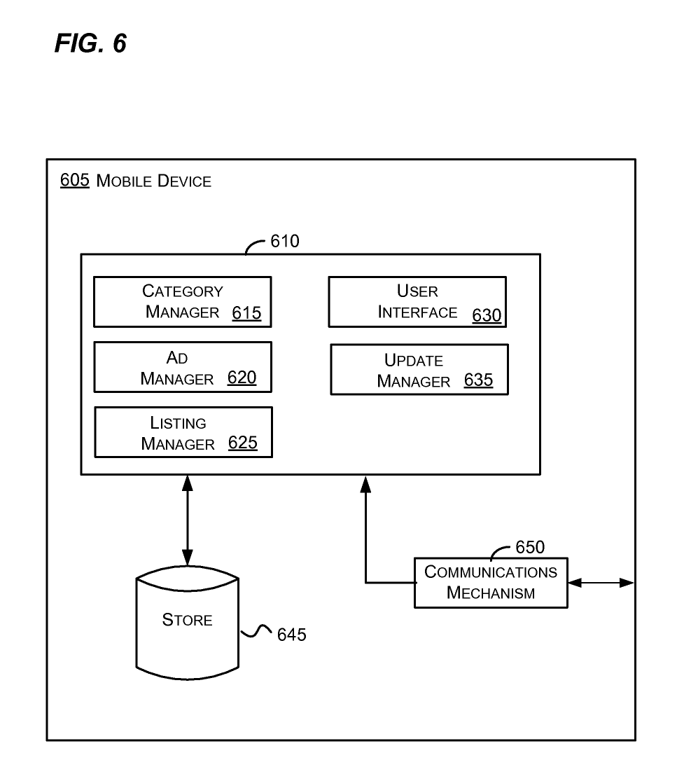

FIG. 6 is a block diagram that includes content components of a mobile device configured in accordance with aspects of the subject matter described herein. The components illustrated in FIG. 6 are exemplary and are not meant to be all-inclusive of components that may be needed or included. In other embodiments, the components and/or functions described in conjunction with FIG. 6 may be included in other components (shown or not shown) or placed in subcomponents without departing from the spirit or scope of aspects of the subject matter described herein. In some embodiments, the components and/or functions described in conjunction with FIG. 6 may be distributed across multiple devices.

Turning to FIG. 6, the mobile device 605 may include content components 610, a store 640, a communications mechanism 645, and other components (not shown). The mobile device 605 may be implemented as described above with reference to FIG. 1.

The content components 610 correspond to the content components 227-231 of FIG. 2. The content components 610 may include a category manager 615, an ad manager 620, a listing manager 625, a user interface 630, an update manager 635, and other components (not shown).

The communications mechanism 650 allows the mobile device 605 to communicate with other entities (e.g., the wireless networks 221-222, the gateways 233-234, the computer 210, the network 220, or the servers). The communications mechanism 650 may be a network interface or adapter, an antenna, or any other mechanism for establishing communications as described in conjunction with FIG. 1.

The store 645 is any storage media capable of storing data and may provide access to advertising content. The term data is to be read to include information, program code, program state, program data, other data, and the like. The store 645 may comprise a file system, database, volatile memory such as RAM, other storage, some combination of the above, and the like and may be distributed across multiple devices. The store 645 may be external, internal, or include components that are both internal and external to the mobile device 605.

The advertising content stored on the store 645 may include zero or more ads and zero or more listings. The advertising content is associated with categories. Each category is associated with zero or more ads and zero or more listings. The store 645 includes all content needed to display any ads and listings included in the advertising content independently of any database external to the mobile device 605. In other words, after downloading the advertising content (e.g., to obtain a database of advertising content), when displaying advertising content, the mobile device 605 does not need to access additional advertising content that has not been downloaded to the mobile device 605.

The category manger 615 is operable to display categories via the user interface. In one embodiment, categories may be displayed in a hierarchical manner by first displaying main categories, then displaying subcategories, if any, of a selected main category, then displaying subcategories, if any, of a selected subcategory, and so forth.

In another embodiment, the category manager 615 may be further operable to display via the user interface 630 an alphabet of letters that start the categories. When a user selects a letter, the category manager 615 may operate to navigate to and display, via the user interface 630, categories starting with a letter selected via the user interface 630.

The ad manager 620 is operable to retrieve ads solely from the store 645. The ad manager 620 may retrieve ads that are associated with an indicated (e.g., selected) category.

The listing manager is operable to retrieve listings from the store 645. The listing manger 625 may retrieve listings that are associated with an indicated (e.g., selected) category.

The user interface 630 is operable to receive an indication of a category and to display any ads and listings associated with the category. The user interface 630 may include elements as indicated in conjunction with FIGS. 3-5.

The update manager 635 may be operable to receive updates to the advertising content and to merge the updates with the advertising content stored on the store.

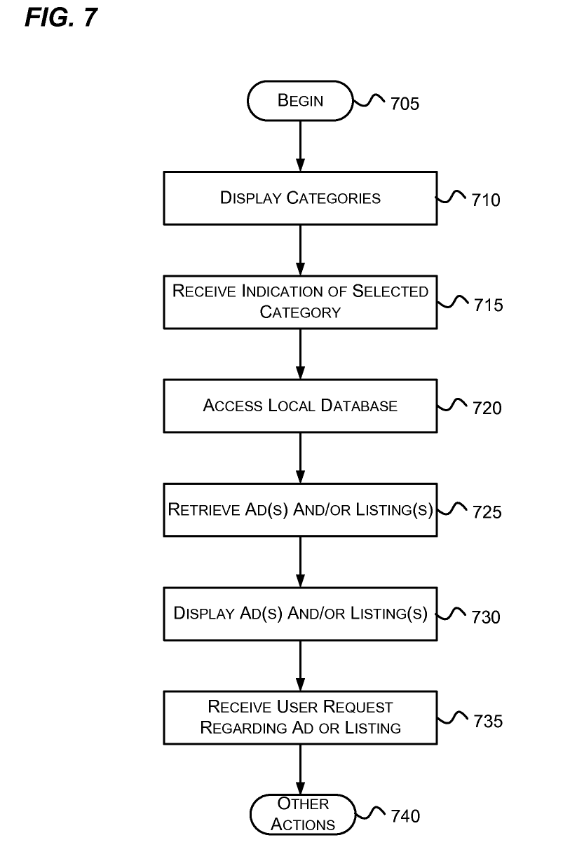

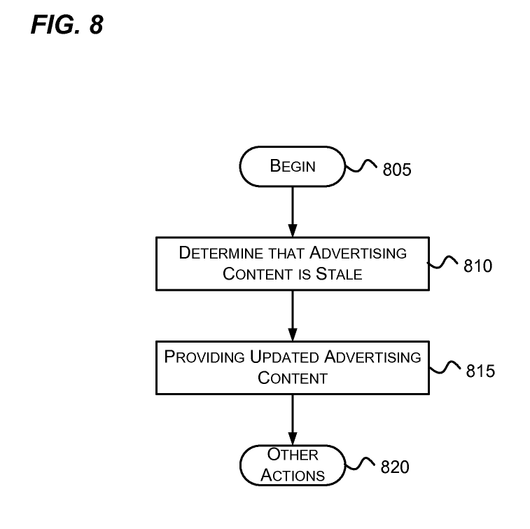

FIGS. 7-8 are flow diagrams that generally represent actions that may occur in accordance with aspects of the subject matter described herein. For simplicity of explanation, the methodology described in conjunction with FIGS. 7-8 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

FIG. 7 is a flow diagram that generally represents exemplary actions that may occur on a mobile device in accordance with aspects of the subject matter described herein. Turning to FIG. 7, at block 705, the actions begin.

At block 710, categories of advertising content are displayed. Each category is associated with zero or more ads and zero or more listings. Each ad includes advertising content about an entity. Each listing includes contact information about an entity. For example, referring to FIG. 3, the categories 320 are displayed on the user interface 305.

At block 715, an indication of one of the categories is received. For example, referring to FIG. 3, an indication of a selection of the “attorneys-bankruptcy” category may be received via the user interface 305. This indication may be received from a user that scrolls to the category and selects the category, by receiving main category/subcategory hierarchical navigation commands (e.g., by receiving an indication of a main category (e.g., “attorneys”) followed by an indication of a subcategory (e.g., “bankruptcy”), by receiving other hierarchical navigation commands (e.g., selecting a letter and then scrolling to the appropriate category), or the like.

At block 720, a local database is accessed to obtain ads or listings. The local database is included on the mobile device and includes the categories and any ads and listings associated with the categories. For example, referring to FIG. 6, the ad manager 620 and the listing manager 625 may be used to access ads and listings on the store 645 of the mobile device 605.

At block 725, ads or listings are retrieved from the database. For example, referring to FIG. 6, one or more ads associated with “attorneys-bankruptcy” are retrieved from the store 645.

At block 730, the ads or listings are displayed. For example, referring to FIG. 5, listings are displayed in the pane 525 of the user interface 505.

At block 735, an indication of a user request regarding an ad or listing is received. For example, referring to FIG. 5, while listing 1 is selected, a selection of the map element 530 is received. In response to this indication, a map of a location associated with the selected listing may be provided. If a user selects the call element 540, a number associated with the listing 1 may be dialed. If the user selects the info element 535, additional information regarding the listing 1 may be displayed.

At block 740, other actions, if any, may be performed. These other actions may include, for example, receiving a database that includes the advertising content from an entity outside the mobile device and storing the database or a portion thereof on a storage media of the mobile device, receiving an indication that the database needs to be updated, receiving updates to the database, merging the updates with the database, and storing updates on a storage media of the mobile device, other actions, and the like.

FIG. 8 is a flow diagram that generally represents exemplary actions that may occur to update content in accordance with aspects of the subject matter described herein. At block 805, the actions begin.

At block 810, a determination is made that advertising content on a mobile device is stale. This determination may be made, for example, by receiving versioning data from the mobile device and comparing the versioning data with versioning data of most recent advertising data. If the versioning data of the mobile device is not equal to the versioning data of the most recent advertising data, the advertising content on the mobile device may be determined to be stale. For example, referring to FIG. 2, the computer 210 or servers 205-206 may receive versioning data from a mobile device and may determine whether the advertising content on the mobile device is stale.

At block 815, updated advertising content is provided to the mobile device. The updated advertising content may be provided via one or more networked entities that sit between the mobile device and a server sending the updated advertising content. For example, referring to FIG. 2, the server 205 may provide updated advertising content to the mobile device 217 by sending the updated advertising content via entities in the network 220 and the computer 210.

At block 820, other actions, if any, are performed.

As can be seen from the foregoing detailed description, aspects have been described related to advertising content for mobile devices. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a mobile device, the method comprising:
displaying categories of advertising content, each category associated with zero or more ads and zero or more listings, each ad including advertising content about an entity, each listing including contact information about an entity;
receiving an indication of one of the categories;
accessing a database included on the mobile device, the database including the categories and any ads and listings associated with the categories;
retrieving solely from the database zero or more ads associated with the one of the categories and zero or more listings associated with the one of the categories; and
displaying an ad, if any, associated with the one of the categories.

2. The method of claim 1, wherein each ad is sized to be viewable without scrolling on a display of the mobile device.

3. The method of claim 1, wherein the database includes advertising content that is associated with only one geographical region that includes one city or two or more cities that are adjacent to each other, the geographical region being smaller than a county including the two or more cities.

4. The method of claim 1, wherein retrieving solely from the database zero or more ads associated with the one of the categories and zero or more listings associated with the one of the categories comprises retrieving the zero or more ads and the zero or more listings without accessing a network during retrieving to obtain the zero or more ads and the zero or more listings.

5. The method of claim 1, wherein receiving an indication of one of the categories comprises displaying hierarchical navigation elements, receiving an indication of a main category, and optionally receiving an indication of one or more subcategories that are related to the main category.

6. The method of claim 1, wherein receiving an indication of one of the categories comprises displaying letters of an alphabet, receiving an indication of one of the letters, displaying categories that start with the one of the letters, and receiving a selection of one of the categories that start with the one of the letters.

7. The method of claim 1, further comprising receiving the database from an entity outside the mobile device and storing the database entirely on a storage media of the mobile device.

8. The method of claim 1, further comprising receiving an indication that the database needs to be updated, receiving updates to the database, merging the updates with the database, and storing updates on a storage media of the mobile device.

9. The method of claim 1, further comprising receiving an indication of a selection of a map element and in response providing a map of a location associated with a selected entity.

10. The method of claim 1, further comprising receiving an indication of a selection of a call element and in response automatically dialing a telephone number associated with a selected entity.

11. The method of claim 1, wherein the mobile device comprises a device designed to be held in one or two human hands while interacting with the device.

12. In a computing environment, a mobile device, comprising:
a store operable to provide access to advertising content, the advertising content including ads and listings, the advertising content associated with categories, each category associated with zero or more ads and zero or more listings of the advertising content, the store including all content needed to display the ads and listings included in the advertising content independently of any database external to the mobile device;
a user interface operable to receive an indication of a category and to display any ads and listings associated with the category;
an ad manager operable to retrieve solely from the store any ads associated with the category; and
a listing manager operable to retrieve solely from the store any listings associated with the category.

13. The mobile device of claim 12, wherein the mobile device comprises a device designed to be held in one or two hands while interacting with the device.

14. The mobile device of claim 12, further comprising a category manager operable to display categories via the user interface in a hierarchical manner, by first displaying main categories, then displaying subcategories, if any, of a selected main category, then displaying subcategories, if any, of a selected subcategory.

15. The mobile device of claim 12, further comprising a category manager operable to display via the user interface categories together with an alphabet of letters that start the categories.

16. The mobile device of claim 15, wherein the category manager is further operable to navigate to and display, via the user interface, categories starting with a letter selected via the user interface.

17. The mobile device of claim 12, further comprising an update manager operable to receive updates to the advertising content and to merge the updates with the advertising content stored on the store.

18. A computer storage medium having computer-executable instructions, which when executed perform actions, comprising:
determining that advertising content on a mobile device is stale, the advertising content including ads and listings, the advertising content associated with categories, each category associated with zero or more ads and zero or more listings of the advertising content, each ad sized to be viewed on a single page of the mobile device, the advertising content including all data needed to display the ads and listings independent of any other data not included on the mobile device; and
providing updated advertising content to the mobile device.

19. The method of claim 18, wherein providing updated advertising content to the mobile device comprises sending the updated advertising content via one or more networked entities that sit between the mobile device and a server sending the updated advertising content.

20. The method of claim 18, wherein determining that advertising content on a mobile device is stale comprises receiving versioning data from the mobile device and comparing the versioning data with versioning data of most recent advertising data.
